(19) United States
(12) Patent Application Publication
(10) Pub. No.: US 2026/0007260 A1
(43) Pub. Date: Jan. 8, 2026

(54) CONNECTING PIN AND GREEN PLANT FENCE WITH THE SAME

(71) Applicant: Hangzhou Zhongmeng Import and Export Co.,LTD., Hangzhou (CN)

(72) Inventor: Cheng ZHANG, Hangzhou (CN)

(73) Assignee: Hangzhou Zhongmeng Import and Export Co.,LTD., Hangzhou (CN)

(21) Appl. No.: 18/763,324

(22) Filed: Jul. 3, 2024

(51) Int. Cl. A47G 7/04; E04H 17/16; F16B 9/00

(52) U.S. Cl. CPC A47G 7/04; E04H 17/16; F16B 9/07

(57) ABSTRACT

The application relates to the technical field of simulation plants, in particular to a connecting pin and a green plant fence with the same. The connecting pin includes a connecting rod and an inserting connection rod which are integrally connected, where a limiting convex ring is integrally arranged on an outer wall of one side, close to the inserting connection rod, of the connecting rod, a first inserting connection hole is formed in an outer side wall of the inserting connection rod, a clamping connection convex block is arranged at one end, away from the inserting connection rod, of the connecting rod, and the clamping connection convex block and the connecting rod are arranged coaxially and integrally.

### TECHNICAL FIELD

The application relates to the technical field of simulation plants, in particular to an simulation plant inserting connection rack.

### BACKGROUND

With the increasing demand of the public for working and living environments, people usually choose to decorate indoor and outdoor environments with plants to bring them closer to nature. But arrangement of real plants will increase maintenance cost in the later stage, and people need to spend a lot of time taking care of the plants. For novice planters, taking care of the plants is even more difficult. Introduction of simulation plants has basically solved the problems of natural environment creation and subsequent maintenance, and the simulation plants can be arranged once and for all. The realism of the simulation plants is getting higher and higher, the simulation plants can be consistent at all seasons, simple in maintenance, and low in price, and the shortcomings that the plants attract flying insects can also be overcome.

Existing simulation plants are usually arranged on a grid-shaped rack body, and the grid-shaped distribution of the rack body allows the simulation plants and matching grass to penetrate through grid gaps to form a winding effect on the rack body, improving ornamental value of the simulation plants. But intersection points of existing grid-shaped racks are usually used as connection points, and the rack body improves structural stability through each connection point.

However, plants cannot be arranged at connection positions of existing rack body usually, and when the plants are wrapped around the rack body, a situation where a blank area is too large occurs, leading to a decrease in the realism and aesthetics of the simulation plants.

### SUMMARY

In order to improve the situation of large blank area between plants in a grid-shaped rack, and improve realism and aesthetics of simulation plants, the application provides a connecting pin and a green plant fence with the same.

In a first aspect, the connecting pin provided by the application adopts the following technical solution:

the connecting pin includes a connecting rod and an inserting connection rod which are integrally connected, where a limiting convex ring is integrally arranged on an outer wall of one side, close to the inserting connection rod, of the connecting rod, a first inserting connection hole is formed in an outer side wall of the inserting connection rod, a clamping connection convex block is arranged at one end, away from the inserting connection rod, of the connecting rod, and the clamping connection convex block and the connecting rod are arranged coaxially and integrally.

By adopting the above technical solution, the connecting rods on the connecting pins can be connected to the green plant fence, the first inserting connection holes are formed in the inserting connection rods to allow inserting connection of the simulation green plants, lengths of the connecting rods connected to the green plant fence are fixed through arrangement of the limiting convex rings, and interference is prevented from being generated between the simulation green plants and the green plant fence when inserting connection of the simulation plants is performed on the inserting connection rods. The connecting pins provide connecting shafts for the green plant fence on one hand, and also provide a platform for inserting connection and fixation of the simulation green plants on the other hand, whereby connecting positions of a fence rack body can also be covered with green plants, intensity of every two adjacent plants is increased, a situation of large blank area between plants in a grid-shaped rack is avoided, and realism and aesthetics of simulation plants are improved.

Further, a centerline of the first inserting connection hole is perpendicular to a centerline of the inserting connection rod.

By adopting the above technical solution: the centerline of the first inserting connection hole is perpendicular to the centerline of the inserting connection rod, whereby green plants can be inserted and mounted in an angle perpendicular to the inserting connection rods, in such inserting connection manner, a coverage rate of the plants on connecting positions of the fence rack body is increased to the maximum extent, the situation of large blank area between the plants is avoided, and the realism and the aesthetics of the simulation plants are improved.

Further, an included angle between an extension direction of the first inserting connection hole and the inserting connection rod is an acute angle.

By adopting the above technical solution: the included angle between the extension direction of the first inserting connection hole and the connecting rod is the acute angle, such arrangement enables a plant coverage area of the simulation green plants to be enlarged, provides a better inserting and mounting display perspective for viewers, has an effect of filling up the blank areas, and facilitates increase in the realism and the aesthetics of the simulation plants.

Further, a second inserting connection hole is formed in an end surface of one end, away from the connecting rod, of the inserting connection rod, and the second inserting connection hole mutually communicates with the first inserting connection hole.

By adopting the above technical solution: the second inserting connection holes are also formed in the inserting connection rods and mutually communicate with the first inserting connection holes, whereby the green plants can be more intensively inserted and mounted on the same connecting pin, which facilitates increase in the realism and the aesthetics of the simulation plants.

In a second aspect, the green plant fence provided by the application adopts the following technical solution:
the green plant fence includes the connecting pins as described in the first aspect, and further includes a plurality of first support rods, a plurality of second support rods and simulation green plants, the first support rods and the second support rods are successively crossed to form a plurality of crossing positions, the connecting rods on the connecting pins successively penetrate through the first support rods and the second support rods to enable the first support rods and the second support rods to be rotationally connected, the limiting convex rings are mutually abutted with the first support rods, the clamping connection convex blocks are mutually abutted with the second support rods, and the simulation green plants are in inserting connection to the first inserting connection holes and/or the second inserting connection holes.

By adopting the above technical solution, the connecting pins have an effect of enabling the first support rods and the second support rods to be rotationally connected on one hand, and can provide the platform for inserting connection of the simulation green plants through the inserting connection rods on the other hand, the quantity of the simulation green plants inserted and mounted on the connecting pins is increased through cooperative arrangement of the first inserting connection holes and the second inserting connection holes, and the simulation plants can be intensively inserted and mounted on the green plant fence, which facilitates increase in the realism and the aesthetics of the simulation plants.

Further, connecting columns are arranged on the simulation green plants, a spherical bulge is integrally arranged at one end of each connecting column, and a simulation plant body is connected to the other end of each connecting column.

By adopting the above technical solution, the spherical bulges are arranged at ends of the connecting pins, whereby clamping connection and fixation effects can be achieved between the connecting pins and the primary connecting rods, stability of main plants and matching grass mounted on a telescopic rack is improved, and increase in the realism and the aesthetics of the simulation plants is facilitated.

Further, the green plant fence further includes expanding racks, where each expanding rack includes a primary connecting rod and a plurality of secondary connecting rods, one end of the primary connecting rod is inserted and mounted in the first inserting connection hole of the inserting connection rod, all the secondary connecting rods are fixedly connected to one side, away from the inserting connection rod, of the primary connecting rod, and inserting openings allowing the simulation green plants to be inserted and mounted are formed in end surfaces of the secondary connecting rods.

By adopting the above technical solution, the expanding racks can expand the quantity of the plants inserted and mounted on the inserting connection rods, one end of each primary connecting rod can be in inserting connection to the first inserting connection holes or the second inserting connection holes, the plurality of the secondary connecting rods are fixedly connected to the primary connecting rods, and the secondary connecting rods are used for allowing the simulation green plants to be inserted and mounted, whereby more simulation green plants are mounted on the green plant fence, the coverage area of the plants is enlarged to the maximum extent, the effect of filling up the blank area is achieved, and increase in the realism and the aesthetics of the simulation plants is facilitated.

Further, clamping grooves allowing the spherical bulges to be clamped are formed in outer side walls of the primary connecting rod, and the clamping grooves are formed in the length direction of the primary connecting rod.

By adopting the above technical solution, the clamping grooves are formed in the primary connecting rods, when the primary connecting rods and the simulation plants are respectively inserted and mounted in the first inserting connection holes and the second inserting connection holes, the formed clamping grooves enable the connecting columns and the primary connecting rods not to generate mutual interference on one hand, and enable the spherical bulges to be clamped in the clamping grooves on the other hand, achieving the effect of fixing relative positions of the connecting columns and the primary connecting rods.

In summary, the application has at least one beneficial technical effect as follows:
1. The connecting pins can be connected to the green plant fence on one hand, and can also be used for inserting connection of the simulation green plants on the other hand. The connecting rods of the connecting pins provide the connecting shafts for the green plant fence, and the first inserting connection holes in the inserting connection rods of the connecting pins are formed to provide the platform for inserting connection and fixation of the simulation green plants. The limiting convex rings of the connecting pins enable the lengths of the connecting rods when being connected to the green plant fence to be fixed, and interference is prevented from being generated between the simulation green plants and the green plant fence when the simulation plants are in inserting connection to the inserting connection rods.
2. The second inserting connection holes in the inserting connection rods mutually communicate with the first inserting connection holes, whereby the green plants can be more intensively inserted and mounted on the same connecting pin, which facilitates increase in the realism and the aesthetics of the simulation plants.
3. The expanding racks can expand the quantity of the plants inserted and mounted on the inserting connection rods, one end of each primary connecting rod can be in inserting connection to the first inserting connection holes or the second inserting connection holes, and the plurality of the secondary connecting rods are used for allowing the simulation green plants to be inserted and mounted, whereby more simulation green plants are mounted on the green plant fence, the coverage area of the plants is enlarged to the maximum extent, and the effect of filling up the blank area is achieved.

### BRIEF DESCRIPTION OF DRAWINGS

FIG. 1 shows a schematic diagram of an overall structure of a connecting pin in Embodiment 1 of the application.

FIG. 2 shows an exploded schematic diagram of a structure of the connecting pin in the Embodiment 1 of the application.

FIG. 3 shows a schematic diagram of an overall structure of an expanding rack for matching grass in the Embodiment 1 of the application.

FIG. 4 shows a schematic diagram of an overall structure of simulation plants in the Embodiment 1 and the Embodiment 2 of the application.

FIG. 5 shows a schematic diagram of an overall structure of a green plant fence in the Embodiment 1 of the application.

FIG. 6 shows a schematic diagram of an overall structure where simulation plants and matching grass are mounted on a green plant fence in Embodiment 1 of the application.

FIG. 7 shows a sectional schematic diagram of the connecting pin in the Embodiment 2 of the application.

FIG. 8 shows a schematic diagram of an overall structure where simulation plants are mounted in a green plant fence in the Embodiment 2 of the application.

Description of reference numerals: 1—connecting rod; 11—clamping connection convex block; 2—inserting connection rod; 21—first inserting connection hole; 22—second inserting connection hole; 3—limiting convex ring; 4—first support rod; 5—second support rod; 6—simulation green plant; 61—connecting column; 62—spherical bulge; 7—expanding rack; 71—primary connecting rod; 711—clamping groove; 72—secondary connecting rod; 721—inserting opening.

### DETAILED DESCRIPTION OF THE EMBODIMENTS

In order to make the purpose, technical solutions, and advantages of the application clearer, the application will be further described in detail in combination with accompanying drawings 1-8, Embodiment 1 and Embodiment 2.

The words used to describe positional relationship, such as “up”, “down”, “front”, and “back”, as described in the Embodiment 1 and the Embodiment 2, are determined based on placement and mounting positions of an inserting connection rack of simulation green plants 6, in conventional use state.

### Embodiment 1

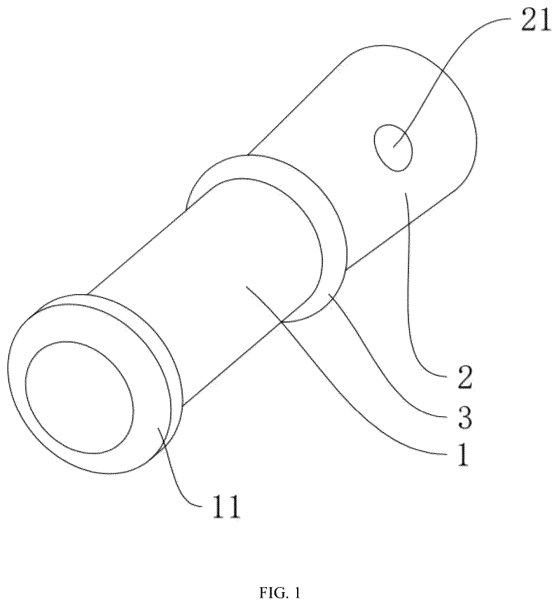

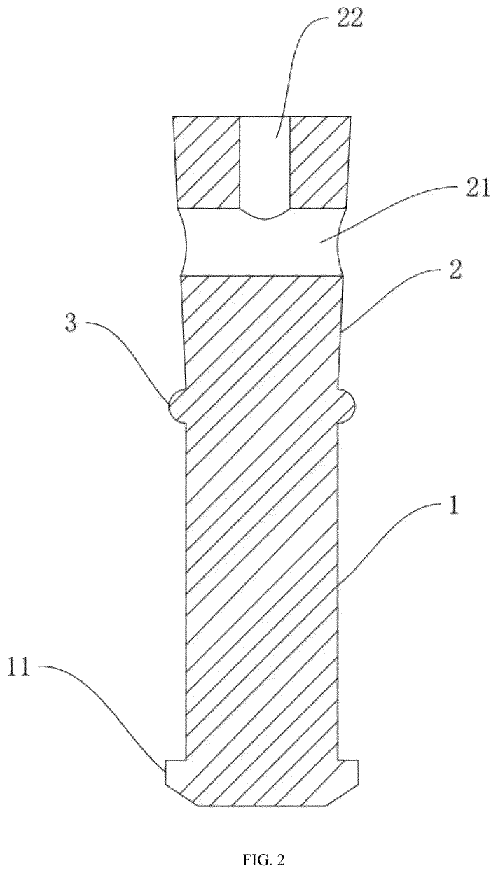

The application embodiment discloses a connecting pin and a green plant fence with the same. Referring to FIG. 1 and FIG. 2, the connecting pin includes a connecting rod 1 and an inserting connection rod 2 which are coaxially arranged and integrally connected, a limiting convex ring 3 is fixedly connected to an outer wall of one side, close to the inserting connection rod 2, of the connecting rod 1, and a clamping connection convex block 11 is coaxially and fixedly connected to an end, away from the inserting connection rod 2, of the connecting rod 1.

A first inserting connection hole 21 is formed in the inserting connection rod 2 in a radial cut-through manner, and located in a middle position of the inserting connection rod 2, a second inserting connection rod 2 is coaxially arranged in an end surface of one side, away from the connecting rod 1, of the inserting connection rod 2, and the second inserting connection rods 2 are mutually perpendicular and are in mutual communication.

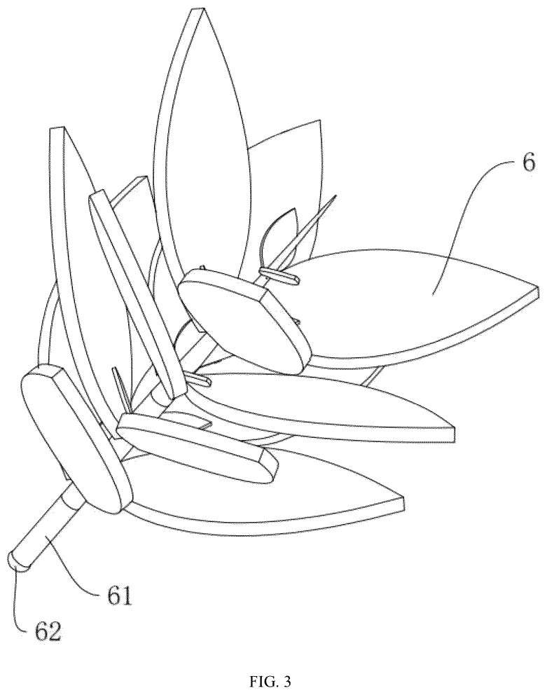

The green plant fence includes simulation green plants 6, first support rods 4 and second support rods 5. Referring to FIG. 3, connecting columns 61 for allowing first inserting connection holes 21 or second inserting connection holes 22 to be inserted are arranged on the simulation green plants 6, and spherical bulges 62 are integrally connected to one end, away from plant bodies of simulation green plants 6, of the connecting columns 61.

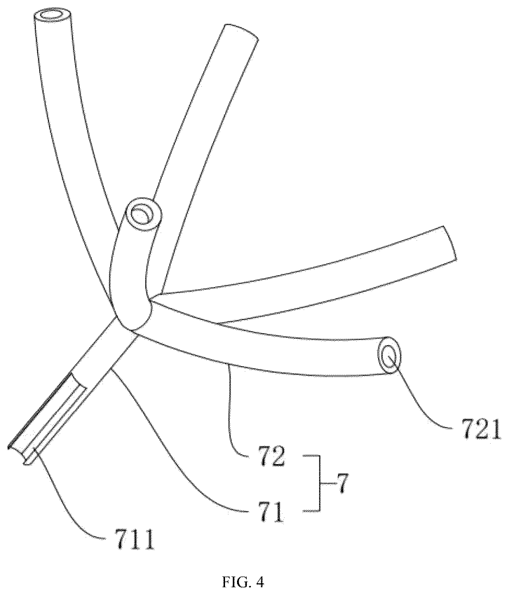

Referring to FIG. 4, expanding racks 7 used for expanding the inserting connection quantity of the simulation green plants 6 are also arranged on the green plant fence, and each expanding rack 7 includes a primary connecting rod 71 and a plurality of secondary connecting rods 72. The primary connecting rods 71 are inserted and mounted in the first inserting connection holes 21 or the second inserting connection holes 22, and the secondary connecting rods 72 are all fixedly connected to the primary connecting rods 71. In the embodiment, the quantity of the secondary connecting rods 72 is preferably five, and the five secondary connecting rods 72 are all fixedly connected to one end, away from the inserting connection rod 2, of the primary connecting rod 71. The secondary connecting rods 72 are obliquely arranged, and an included angle between each secondary connecting rod 72 and the primary connecting rod 71 is an obtuse angle. Inserting openings 721 for allowing the connecting columns 61 of the simulation green plants 6 to be inserted and fixed are axially formed in end positions, away from the primary connecting rods 71, of the secondary connecting rods 72.

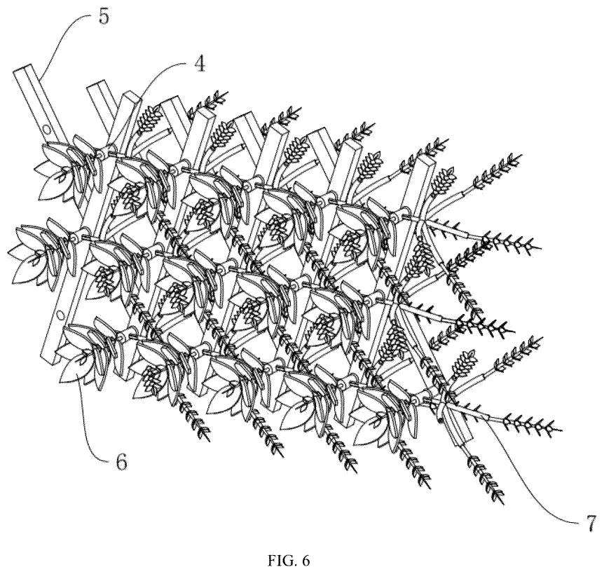

Clamping grooves 711 are formed in outer side walls of the primary connecting rods 71 in a length direction, and in combination with FIG. 6, when the expanding racks 7 are mounted in the first inserting connection holes 21 and the simulation green plants 6 are mounted in the second inserting connection holes 22, the spherical bulges 62 can be clamped in the clamping grooves 711. The spherical bulges 62 can be in clamped connection and fixation to any position of the clamping grooves 711 in a length direction, to adjust relative positions of the simulation green plants 6 and the expanding racks 7.

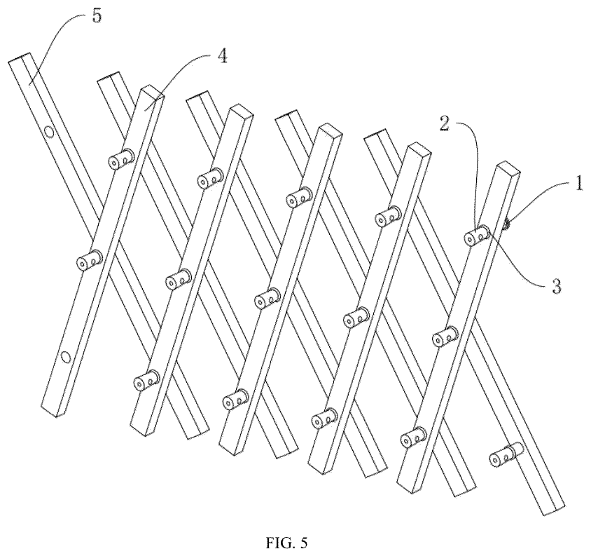

Referring to FIG. 5 and FIG. 6, the first support rods 4 and the second support rods 5 of the green plant fence are crosswise arranged to form crossing positions, and two opposite surfaces of the first support rods 4 and the second support rods 5 are mutually abutted. The connecting pins in the embodiment are preferably made from plastic materials having certain elasticity, and the connecting rods 1 of the connecting pins perpendicularly penetrate through the crossing positions of the first support rods 4 and the second support rods 5. The connecting rods 1 are rotationally connected to the first support rods 4 and the second support rods 5, the limiting convex rings 3 are abutted against one sides, away from the second support rods 5, of the first support rods 4, and the clamping connection convex blocks 11 are abutted against one sides, away from the first support rods 4, of the second support rods 5. The plurality of first support rods 4 and the plurality of second support rods 5 are used in the embodiment, and users can increase or decrease the quantity of the first support rods 4 and the quantity of the second support rods 5 according to the quantity of the simulation green plants 6, to control the volume of the telescopic rack.

An implementation principle of the inserting connection rack of the simulation green plants 6 in the application embodiment is: rotational connection between the first support rods 4 and the second support rods 5 is achieved through the connecting rods 1 on the connecting pins of the green plant fence. The first inserting connection holes 21 and the second inserting connection holes 22 for inserting connection of the simulation green plants 6 are formed in the inserting connection rods 2 of the connecting pins, more simulation green plants 6 can be inserted and mounted on the expanding racks 7, the clamping grooves 711 are formed in the primary connecting rods 71 of the expanding racks 7, the expanding racks 7 are inserted and mounted in the first inserting connection holes 21 of the connecting rods 1, at the same time, the connecting columns 61 and the spherical bulges 62 of the simulation green plants 6 can be clamped in any positions where the of the inserting openings and the clamping grooves, whereby on one hand, clamping connection and fixation effects between the simulation green plants 6 and the expanding racks 7 can be achieved, and on the other hand, relative positions of the simulation green plants 6 and the expanding racks 7 can also be adjusted.

### Embodiment 2

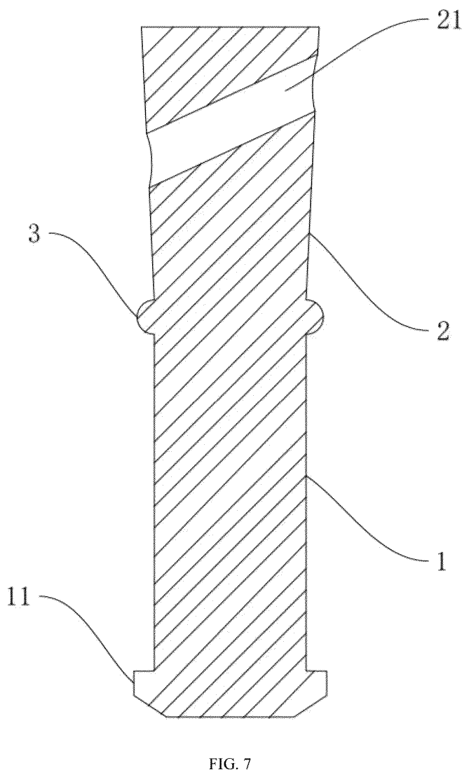

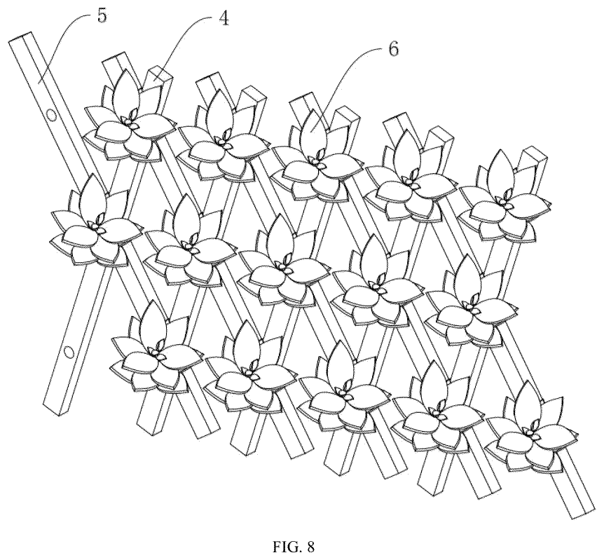

Referring to FIG. 7 and FIG. 8, differences between the Embodiment and the Embodiment 1 lie in that second inserting connection holes 22 in inserting connection rods 2 are canceled in the embodiment, at the same time, an opening manner of the first inserting connection holes 21 is changed, and the first inserting connection holes 21 are obliquely formed in the inserting connection rods 2, whereby the simulation green plants 6 can be obliquely inserted and mounted on the inserting connection rods 2.

The first inserting connection holes 21 radially cut through two sides of the inserting connection rods 2, and an included angle between the extension direction of the first inserting connection holes 21 and a central axis of the connecting pins is an acute angle. Compared with a perpendicular inserting and mounting manner of the simulation green plants 6, by an oblique inserting and mounting manner, the coverage area of the simulation green plants 6 on the green plant fence can be enlarged to the maximum extent, the blank area on the crossing positions of the first support rods 4 and the second support rods 5 can be filled up, and density and aesthetics of the simulation green plants 6 on the green plant fence can be increased.

The above are all preferred embodiments of the application and do not limit the scope of protection of the application. Therefore, any equivalent changes made based on the structure, shape, and principle of the application should be covered within the scope of protection of the application.

What is claimed is:

1. A connecting pin, comprising a connecting rod (1) and an inserting connection rod (2) which are integrally connected, wherein a limiting convex ring (3) is integrally arranged on an outer wall of one side, close to the inserting connection rod (2), of the connecting rod (1), a first inserting connection hole (21) is formed in an outer side wall of the inserting connection rod (2), a clamping connection convex block (11) is arranged at one end, away from the inserting connection rod (2), of the connecting rod (1), and the clamping connection convex block (11) and the connecting rod (1) are arranged coaxially and integrally.

2. The connecting pin according to claim 1, wherein a centerline of the first inserting connection hole (21) is perpendicular to a centerline of the inserting connection rod (2).

3. The connecting pin according to claim 1, wherein an included angle between an extension direction of the first inserting connection hole (21) and the inserting connection rod (2) is an acute angle.

4. The connecting pin according to claim 2, wherein a second inserting connection hole (22) is formed in an end surface of one end, away from the connecting rod (1), of the inserting connection rod (2), and the second inserting connection hole (22) mutually communicates with the first inserting connection hole (21).

5. A green plant fence, comprising the connecting pins according to claim 4, wherein the green plant fence further comprises a plurality of first support rods (4), a plurality of second support rods (5) and simulation green plants (6), the first support rods (4) and the second support rods (5) are successively crossed to form a plurality of crossing positions, the connecting rods (1) on the connecting pins successively penetrate through the first support rods (4) and the second support rods (5) to enable the first support rods (4) and the second support rods (5) to be rotationally connected, limiting convex rings (3) are mutually abutted with the first support rods (4), clamping connection convex blocks (11) are mutually abutted with the second support rods (5), and the simulation green plants (6) are in inserting connection to first inserting connection holes (21) and/or second inserting connection holes (22).

6. The green plant fence according to claim 5, wherein connecting columns (61) are arranged on the simulation green plants (6), a spherical bulge (62) is integrally arranged at one end of each connecting column (61), and a simulation plant body is connected to the other end of each connecting column (61).

7. The green plant fence according to claim 6, further comprising expanding racks (7), wherein each expanding rack (7) comprises a primary connecting rod (71) and a plurality of secondary connecting rods (72), one end of the primary connecting rod (71) is inserted and mounted in the first inserting connection hole (21) of the inserting connection rod (2), all the secondary connecting rods (72) are fixedly connected to one side, away from the inserting connection rod (2), of the primary connecting rod (71), and inserting openings (721) allowing the simulation green plants (6) to be inserted and mounted are formed in end surfaces of the secondary connecting rods (72).

8. The green plant fence according to claim 7, wherein clamping grooves (711) allowing the spherical bulges (62) to be clamped are formed in outer side walls of the primary connecting rod (71), and the clamping grooves (711) are formed in a length direction of the primary connecting rod (71).
